(19) United States
(12) Patent Application Publication
(10) Pub. No.: US 2012/0035342 A1
(43) Pub. Date: Feb. 9, 2012

(54) Method for Producing Polyester Particles at High Throughput in a Line

(75) Inventors: Brent Allan Culbert, Wil (CH); Mauricio Rodrigues, Pocos de Caldas (BR); Andreas Christel, Zuzwil (CH); Franz Giger, Niederuzwil (CH)

(73) Assignee: Buhler AG, Uzwil (CH)

(21) Appl. No.: 13/145,477

(22) PCT Filed: Feb. 23, 2010
(86) PCT No.: PCT/EP2010/052248

§ 371 Date: Jul. 20, 2011

(30) Foreign Application Priority Data
Feb. 23, 2009 (DE) 102009009957.3

(51) Int. Cl. C08G 63/183; B01J 19/00

(52) U.S. Cl. 528/308.3; 422/134

(57) ABSTRACT

The invention relates to a method and to a device for producing a thermoplastic polyester, having the following steps: a) producing polyester pre-polymer particles; b) crystallizing the polyester pre-polymer particles for producing partially crystalline polyester pre-polymer particles; c) heating the partially crystalline polyester pre-polymer particles to a suitable reaction temperature for producing heated polyester pre-polymer particles; d) reacting the heated polyester pre-polymer particles for producing polyester polymer particles having an intrinsic viscosity between 0.70 and 0.95 dl/g. The reaction in step d) takes place in at least one reactor through which the particles flow by means of gravity. The dwell time in the reactor equals between 6 and 30 hours. The particles are supplied at least to step d) at a mass flow of between 40 and 100 t/h. The present invention is characterized in that a settling rate of the particles in the reactor equals between 2 and 6 m/h.

The invention relates to a process for producing a thermoplastic polyester as claimed in the preamble of claim 1.

There are known industrial processes for producing polyester particles by means of a polymerization step in the melt phase, followed by a polymerization step in the solid phase. There is an ongoing need for higher production-line-throughput rates, in order to improve the economics of these processes. To this end, large reactors are required to handle high solid-phase throughputs.

However, high product pressure arises in reactors with large container diameter, and this in turn limits the maximum permissible reactor temperature and thus leads to prolonged residence times and reactors of even greater size. If a process gas flows through the reactor, the pressure drop across the reactor rises with reactor height, and this in turn limits the permissible amount of process gas and thus likewise leads to prolonged residence times and reactors of even greater size. At the same time, the handling of large amounts of product through large reactors results in an ongoing increase in the cost of buildings if the heating of the particles is to take place in situ at a level above the reactor. This can be countered by conveying hot particles from a heating stage to the entry point of the reactor.

Large reactor heights also give rise to large conveying heights. However, when conveying heights are large, damage to the product during conveying becomes the limiting factor.

Economic operation therefore requires that reactor size, the pressure drop in the reactor, and expenditure on buildings be limited. At the same time, there is a requirement to provide a non-aggressive method for conveying hot polyester prepolymer particles.

The present invention therefore has the object of providing a process which maximizes cost-effectiveness and which permits non-aggressive handling of large amounts of polyester particles in the solid phase.

The document DE 102005025975A1 discloses reactors which process up to 60 metric tons/h of polyester pellets. Information is given about the residence time of the materials to be processed in the reactor, reactor volume, and reactor L/D ratio.

However, no information is given as to how the operation of an individual reactor has to be optimized in order to minimize the risk of product adhesion, the resistance to gas flow, and the damage to product due to the conveying method. The description says that a plurality of reactors installed in series are used with a plurality of product input systems and with a plurality of process gas streams.

Unlike the prior art, the present invention allows the following to be prescribed, for high throughput rates through a reactor: the process conditions, the design of the reactor, and the design of the conveying system.

The invention achieves the object by using a process for producing a thermoplastic polyester with the features of claim 1, in that the treatment takes place in the solid phase in reactors through which the particles flow with a high descent velocity, in order to inhibit product caking at maximum temperatures. In claim 1, therefore, the treatment takes place in the solid phase of the polyester in a reactor where the descent velocity of the particles is from 2 to 6 meters per hour.

The heated polyester prepolymer particles are moreover conveyed into the reactor by means of at least one conveying step from an initial level (H0) to an input level (HR), and the input level (HR) here is above the initial level (H0) and has preferably been arranged at a location higher by from 40 to 80 m than the initial level (H0).

The polyester prepolymer particles are moreover preferably passed through a dust-removal apparatus prior to the preheating step.

The present invention also provides an apparatus for producing a thermoplastic polymer, comprising
a) a melt polycondensation reactor for producing polyester prepolymer particles with an intrinsic viscosity of from 0.35 to 0.75 dl/g
b) at least one crystallizer for crystallizing the polyester prepolymer particles to produce semicrystalline polyester prepolymer particles
c) at least one preheater for heating the semicrystalline polyester prepolymer particles to a suitable reaction temperature for producing heated polyester prepolymer particles
d) at least one reactor for producing polyester polymer particles with an intrinsic viscosity of from 0.70 to 0.95 dl/g,
characterized in that,
prior to the preheater c), the arrangement has a dust-removal apparatus, and
the level of input (HR) into the reactor is at a location higher by from 40 to 80 m than the level of output H0 from the preheater c), and
the reactor can preferably be operated with a mass flow rate of from 40 to 100 metric tons of particles per hour, with a residence time of the particles in the reactor of from 6 to 30 hours, and with a descent velocity of from 2 to 6 meters per hour for the particles in the reactor.

In one preferred embodiment, the process of the invention is intended to take place in reactors through which a stream of gas flows with limited pressure drop, the aim here being to allow use of reactors which are not classed as pressure vessels. Conveying of the particles in the invention takes place over a large vertical distance into tall reactors, and preference is given here to a non-aggressive conveying method, at low conveying velocity, since this can reduce product abrasion and dust formation. In one preferred embodiment, the process of the invention uses a pneumatic conveying method.

The process of the invention serves to produce a polyester, and particular preference is given here to the production of polyethylene terephthalate or of one of its copolymers.

Polyesters are crystallizable, thermoplastic polycondensates, examples being polyethylene terephthalate (PET), polybutylene terephthalate (PBT), polytrimethylene terephthalate (PTT), polyethylene naphthalate (PEN), and polytrimethylene naphthalate (PTN), and these can take the form of either homopolymers or copolymers.

Polyester is a polymer that is obtained via polycondensation from its monomers, a diol component and a dicarboxylic acid component. Various diol components having from 2 to 10 carbon atoms are used, mostly linear or cyclic. It is also possible to use various mostly aromatic dicarboxylic acid components usually having from 1 to 3 aromatic rings. Instead of the dicarboxylic acid, it is also possible to use its appropriate diester, in particular dimethyl ester.

Polyesters are usually obtained via a polycondensation reaction with elimination of a low-molecular-weight reaction product. This polycondensation process can take place directly between the monomers or by way of an intermediate which is then reacted via transesterification, and the transesterification process here can in turn take place with elimination of a low-molecular-weight reaction product or via ring-opening polymerization. The polyester thus obtained is in essence linear, but a small number of branching points can be produced.

The polyester can be a virgin material or a recyclate.

Additives can be added to the polyester. Examples of suitable additives are catalysts, dyes and pigments, UV blockers, processing aids, stabilizers, impact modifiers, chemical and physical blowing agents, fillers, nucleating agents, flame retardants, plasticizers, particles which give an improved barrier or improved mechanical properties, reinforcing materials, such as beads or fibers, and also reactive substances, such as oxygen absorbers, acetaldehyde absorbers, or substances that increase molecular weight, and other substances.

Catalysts used are metallic elements, e.g. antimony, germanium, aluminum, or titanium, or else manganese, cobalt, zinc, tin, or calcium. The content of the metallic elements in the polyester is usually from 5 to 400 ppm, and preference is given here to antimony content of from 20 to 300 ppm, germanium content of from 10 to 150 ppm, aluminum content, manganese content, cobalt content, zinc content, tin content, or calcium content, of from 10 to 200 ppm, or titanium content of from 5 to 20 ppm.

A polyester frequently used, especially for producing hollow products, e.g. bottles, is polyethylene terephthalate (PET).

Polyethylene terephthalate is obtained via polycondensation from its monomers, a diol component and a dicarboxylic acid component, with elimination of low-molecular-weight reaction products. Most of the diol component here, in particular more than 90 mol %, is composed of ethylene glycol(1,2-ethanediol), and most of the dicarboxylic acid component, in particular more than 90 mol %, is composed of terephthalic acid, and the total comonomer content here is usually from 1 to 15 mol %, in particular from 2 to 10 mol %.

Instead of terephthalic acid, it is also possible to use its appropriate diester, in particular dimethyl ester. Comonomer content here corresponds to the sum of diol comonomer content and of dicarboxylic acid comonomer content. Diol comonomer content is determined as the number of mols of diol comonomers, based on the total number of mols of the diols. Dicarboxylic acid comonomer content is determined as number of mols of dicarboxylic acid comonomers, based on the total number of mols of dicarboxylic acids.

Comonomers that can be used are other linear, cyclic, or aromatic diol compounds and other linear, cyclic, or aromatic dicarboxylic acid compounds. Typical comonomers are diethylene glycol (DEG), isophthalic acid (IPA), and 1,4-bishydroxymethylcyclohexane (CHDM).

Examples of low-molecular-weight reaction products produced are water, ethylene glycol, acetaldehyde, methanol, and also possibly diols.

Production of polyester prepolymer particles first requires production of a polyester prepolymer melt, which is then cooled and molded to give particles.

The polyester prepolymer melt is produced here via liquid-phase polycondensation of the monomers (melt phase polycondensation). The production of the polycondensate melt usually takes place in a continuous process.

The first stages here are usually the mixing of monomers (paste production), and an esterification stage, followed by a prepolycondensation stage in vacuo. In the conventional polyester production process this is followed by a polycondensation stage likewise in vacuo in a high-viscosity reactor (also termed finisher). This gives a polyester prepolymer with intrinsic viscosity typically from 0.35 dl/g to 0.8 dl/g, in particular above 0.5 dl/g and below 0.7 dl/g (cf. by way of example: Modern Polyesters, Wiley Series in Polymer Science, edited by John Scheirs, J. Wiley & Sons Ltd. 2003; chapter 2.4.2). The polyester can also be produced in a batch process. (cf. by way of example: Modern Polyesters, Wiley Series in Polymer Science, edited by John Scheirs, J. Wiley & Sons Ltd, 2003; chapter 2.4.1).

As an alternative, the abovementioned polycondensation stage in the high-viscosity reactor can be omitted. This gives a low-viscosity polyester prepolymer with intrinsic viscosity typically from 0.2 dl/g to 0.5 dl/g, in particular above 0.3 dl/g and below 0.45 dl/g.

There is also an alternative process for producing the polyester prepolymer melt via melting of polyesters as starting material. This can be achieved by way of example by using a continuous kneader or extruder, or else in a polymerization reactor. The polyesters here are in solid form, for example in the form of pellets, powders, or chips. It is usually advantageous to dry polyesters prior to melting. A further polycondensation step can optionally take place after melting. Melting and depolymerization can also be used to convert a polyester of relatively high viscosity to a lower viscosity level.

The polyester prepolymer melt can also be produced from a mixture made of freshly polymerized and molten polyester, and molten polyester can be added here to the freshly polymerized polyester at the end of the polymerization section or at an intermediate step.

Particularly when recycled polyesters are melted, it is advantageous, prior to combination with freshly polymerized melt, to test the melt by in-line or on-line measurement of quality features such as viscosity or color, in order to divert any low-quality products that may be present, for example to a separate granulation apparatus, and thus prevent contamination of virgin material. The in-line measurement here takes place directly within the molten prepolymer. The on-line measurement can take place in an ancillary stream of the melt or on a test specimen, strand, strip, or pellets, or the like, produced therefrom.

In order to remove solid contaminants, the polyester prepolymer melt is usually subjected to a filtration process by using, as a function of viscosity, sieves with mesh widths of from 5 to 150 μm.

The invention produces a polyester prepolymer melt with intrinsic viscosity of from 0.35 to 0.75 dl/g, preferably above 0.45 dl/g, in particular above 0.5 dl/g, and preferably below 0.7 dl/g, in particular below 0.65 dl/g.

The intrinsic viscosity (IV) here gives the solution viscosity and is determined as specified below:

solution velocity is measured by using a mixture made of phenol/dichlorobenzene (50:50% by weight) as solvent. The polyester specimen is dissolved at a concentration of 0.5% (0.5 g/dl) at 130° C. over a period of 10 minutes. Relative viscosity (R.V.) is measured at 25° C. with an Ubbelohde viscometer (as in DIN 53728, part 3, January 1985).

Relative viscosity is the quotient calculated from the viscosity of the solution and the viscosity of the pure solvent, and this quotient is comparable with the ratio of the corresponding capillary flow velocity. The Huggins equation is used to calculate the value for intrinsic viscosity from the measured relative viscosity:

$$I . V . = \frac{\sqrt{1 + 4 {K}_{H} ( R . V . - 1 )} - 1}{2 * c * {K}_{H}}$$

With the above measurement methods (polymer concentration C=0.5 g/dl and the Huggins constant K_{H}=0.35) the equation becomes:

$$I . V . = \begin{matrix}\sqrt{1 + 1.4 ( R . V . - 1 )} - 1 \\ 0.35\end{matrix} ( dl / g )$$

The viscosity of the polymer can be stated either as intrinsic viscosity (IV) or as average molecular weight (number average: Mn). Conversion of an IV value measured in phenol:dichloromethane=1:1 to average molecular weight is achieved by using the equation

IV=k*Mn̂a a)

where k=2.1 E-4 and a=0.82.

This equation is generally applicable to published data unless there is an explicit statement of a different solvent mixture and the attendant conversion factors.

The average molecular weight can be used to calculate the concentration of terminal groups (CTG) by using the following equation:

CTG=2E6/Mn, a)

where Mn in g/mol is used, and CTG is obtained in mol/metric ton.

From the concentration of terminal carboxy groups (c_{COOH}) and the concentration of terminal groups it is possible to calculate the content of the individual terminal groups, and for simplicity here consideration is given only to the presence of terminal hydroxy and terminal carboxy groups, and therefore CTG=c_{COOH}+c_{OH}.

Terminal carboxy group content X_{COOH}=c_{COOH}/CTG

Terminal hydroxy group content X_{OH}=c_{OH}/CTG=(1−X_{COOH})

c_{COOH} here denotes the concentration of terminal carboxy groups in mol/metric ton, and c_{OH} denotes the concentration of terminal hydroxy groups in mol/metric ton.

In one preferred embodiment of the present invention, the amounts of the diol components and of the dicarboxylic acid components, and also the conditions in the prepolyester production process, are selected in such a way as to produce a prepolyester having a terminal carboxy group content of from 0.25 to 0.6, where the terminal carboxy group content is preferably above 0.30, in particular above 0.35, and preferably below 0.55, in particular below 0.5.

The particles derived from the polyester prepolymer melt can be shaped in various ways. Possible methods are comminution of pieces, strands, or strips which have been molded from the polymer melt, or direct molding of particles, for example via droplet formation or atomization.

The usual method used for the cooling and molding of the polyester prepolymer melt is pelletization.

In pelletization, the polyester prepolymer melt is by way of example forced through a die with an aperture (opening) or with a large number of apertures, and is cut or converted to droplets.

The die apertures are usually round, but their shape can also be different, examples being apertures in the form of slits. Care has to be taken to keep the quantitative product flow rate per die opening within a narrow range, the intention here being to keep the chronological and spatial standard deviation of the individual quantitative product flow rates at from 0.1 to 10%. In order to achieve this, there may be variation of the diameter or length of a die opening as a function of position. At the same time, care has to be taken to maximize uniformity of inflow conditions (pressure, velocity, temperature, viscosity, etc.) for the individual die openings.

The cutting process can either take place directly at the die outlet or can be delayed until after passage through a treatment section.

The cooling process hardens the polyester prepolymer melt. It can use a liquid coolant (e.g. water, ethylene glycol) or gaseous coolant (e.g. air, nitrogen, water vapor), or contact with a cold surface, and combinations of the coolants can also be used.

The cooling process can take place either simultaneously or else prior to or after the shaping process to give particles.

Examples of known pelletization processes are rotomolding, strand pelletization, water-cooled die-face pelletization, underwater pelletization, and hot face pelletization, and also droplet formation or atomization. Processes of this type are described by way of example in the following specifications: WO00/23497 Matthaei, WO01/05566 Glockner et al., WO05/087838 Christel et al., WO03/054063 Culbert et al., and also WO96/22179 Stouffer et al., and these are incorporated concomitantly into the present invention.

If a liquid coolant is used, this has to be removed, and this is achieved to some extent by way of simple separators, such as sieves or grids, and can additionally be achieved via centrifugal force, for example in a centrifugal drier, via impact, for example in an impact drier, and/or via a stream of gas.

Average pellet size is intended to be from 0.1 mm to 10 mm, preferably from 0.5 mm to 3 mm, and in particular from 0.85 to 2.5 mm. Average pellet size is the statistical average of the average pellet diameter, which is obtained from the average of pellet height, pellet length, and pellet width.

The intention is to keep pellet size distribution within a narrow range. The standard deviation of pellet weights of 100 pellets measured is preferably from 2 to 20%. The pellets can be of defined shape, for example being cylindrical, spherical, droplet-shaped, or spheroidal, or they can have a designed shape as proposed by way of example in EP0541674B1.

It is possible to use solid pellets or porous pellets which are obtained by way of example via foaming, sintering, and the like.

The temperature at the end of the cooling process can be below the glass transition temperature of the polyester, and this permits storage and/or transport of the pellets over a prolonged period.

However, it is also possible to keep the average temperature of the prepolyester pellets at a relatively high level in order to improve the energy efficiency of the subsequent processes. To this end, it is possible to raise the temperature of the coolant and/or to select an appropriately short residence time in the coolant.

Although some crystallization can take place before production of the polyester prepolymer particles is completed, a crystallization step is usually necessary in order to obtain semicrystalline polyester prepolymer particles.

The crystallization process can take place independently or together with particle production. There can be a plurality of apparatuses for producing particles connected to a crystallization apparatus. The crystallization process can take place in one step or in a plurality of steps, and therefore in one apparatus or in a plurality of apparatuses installed in series. The crystallization process can take place continuously or batchwise. The crystallization process can optionally take place in two or more apparatuses operated in parallel.

The crystallization process uses the processes known from the prior art, for example thermal crystallization, solvent-induced crystallization, or crystallization via mechanical orientation. It is preferable that the crystallization process uses a thermal method, thus producing a thermally semicrystallized polycondensate.

The crystallization process is intended to take place at a suitable temperature over a suitable residence time. The crystallization process is intended to achieve at least a degree of crystallization which permits avoidance of caking or clumping in further thermal treatment, e.g. drying or solid phase polycondensation.

The appropriate temperature range can be found by recording crystallization halflife time (t) measured by DSC as a function of temperature. Upper and lower limits of this range are defined via the temperature at which crystallization halflife time is about 10 times the minimum crystallization halflife time t min. Since it is difficult to determine very short crystallization halflife times (t½), t½ min=1 minute is used as minimum value.

The appropriate crystallization time is obtained from the time required to heat the product to the crystallization temperature plus at least the crystallization halflife time at the given temperature, and in order to achieve adequate crystallization here it is preferable that the heating time selected is from 2 to 20 halflife times.

The intention is to keep the crystallizing prepolymer particles in motion relative to one another, in order to inhibit caking of the same. Suitable crystallization reactors are vibrating reactors, rotating reactors, reactors with agitators, and also reactors through which a process gas flows, where the flow velocity of the process gas must be sufficient to cause motion of the prepolymer particles. Flow velocities in the range from 1 to 6 m/s are preferred, in particular greater than 1.5 m/s and smaller than 4 m/s. The gas velocity here is the superficial velocity, i.e. the quantity of gas per unit of time divided by the cross section of the treatment space.

Particularly suitable crystallization reactors are fluidized-bed crystallizers, since these do not have any tendency to form dust.

The appropriate temperature range in the case of polyethylene terephthalate is from 100 to 220° C., and a degree of crystallization of at least 20%, preferably at least 30%, is achieved in from 5 to 20 minutes.

The crystallization process can take place from the glassy state, i.e. after cooling to a temperature below the crystallization temperature, in particular below the glass transition temperature Tg.

Other suitable processes are those where the crystallization process takes place at least to some extent from the melt, where a rise in crystallinity takes place during the cooling phase and/or during a retention phase at elevated temperature.

If the temperature of the polyester prepolymer particles on entry into the crystallization process is below the appropriate crystallization temperature, the polyester prepolymer particles have to be heated. This can be achieved by way of example by way of a heated wall of the crystallization reactor, by way of heated internals within the crystallization reactor, via radiation, or via injection of a hot process gas.

When the degree of crystallization is increased, any possible residues of the liquid from the pelletization process are also simultaneously removed.

If the crystallization process uses a process gas in a circuit, there has to be sufficient fresh gas or purified process gas added to the circuit so as to avoid any excessive increase in concentration of the liquid or of other substances that diffuse out of the material. Examples of process gases that can be used are air, water vapor, or inert gases, such as nitrogen or CO₂, or a mixture thereof. The process gases can comprise additives, where these either have a reactive effect on the product to be treated or become passively deposited on the product to be treated.

There can be other assembles integrated into the process gas circuit, examples being heat exchangers, separation assemblies, such as filters or cyclones, gas-conveying assemblies, such as blowers, compressors or fans, gas-purification systems such as gas scrubbers, combustion systems or adsorption systems, or devices such as flaps, valves, or diverter systems.

Prior to a crystallization process, the polyester prepolymer particles can optionally be subjected to a treatment for reducing their tendency toward adhesion, as described in PCT/CH2008/000389, incorporated concomitantly into the present invention.

Prior to the crystallization process, the polyester prepolymer particles can optionally be heated. This can be achieved in a preheating stage, where the heat can be supplied from a subsequent cooling step, as described in EP01789469B1, incorporated concomitantly into the present invention. In an alternative method, the heat can also be generated directly for the preheating stage or can derive from heat recovery from a heat source from an upstream process of melt phase polymerization. In the case of polyethylene terephthalate production it is possible by way of example to use the vapor from the column for separation of water and ethylene glycol as heat source for the preheating stage.

Particularly suitable apparatuses for the crystallization process are fluidized-bed apparatuses as described by way of example in EP-1 425 146 A2, the relevant content of which is incorporated by reference into this application. The heating to crystallization temperature and the subsequent crystallization process can take place in one or more crystallization apparatuses. The size of the required apparatuses here is stated by giving the sum of all of the areas of the sieve plates of the apparatuses, and the resultant sieve plate areas here for treating from 40 to 100 metric tons/h are from 10 to 100 m². Crystallization of cold PET pellets requires sieve plate areas of from 20 to 60 m².

The crystallization process has to be followed by a step for the heating of the semicrystalline polyester prepolymer particles to a suitable reaction temperature, in order to obtain heated polyester prepolymer particles.

It has been found in the invention that, for operation of a system with high throughput, it is highly advantageous to pass the semicrystalline polyester prepolymer particles through a dust-removal apparatus, since otherwise there is a loss of efficiency in the conduct of the subsequent steps.

The heating process can take place independently or together with the crystallization process. There can be a plurality of crystallization apparatuses connected to a heating apparatus. The heating process can take place in one step or in a plurality of steps, and can therefore take place in one apparatus or in a plurality of apparatuses installed in series. The heating process can take place continuously or batchwise. The heating process can optionally take place in two or more apparatuses operated in parallel.

Suitable apparatuses for the heating process are rotating reactors, reactors with agitators, and also reactors through which a process gas flows.

The appropriate reaction temperature is within a temperature range of which the lower limit derives from a minimum reaction rate of the polyester and the upper limit is a temperature slightly below the melting point of the polyester. The reaction temperature is usually below the crystalline melting point of the polyester by from 5 to 80° C.

A conditioning process takes place simultaneously with the heating process and improves the crystal structure in such a way as to reduce the tendency of the polyester prepolymer particles toward adhesion. The conditioning process here can take place at the appropriate reaction temperature or at a temperature which is above the appropriate reaction temperature by from 1 to 30° C. If the conditioning process takes place at a higher temperature, the temperature of the polyester prepolymer particles has to be lowered to the appropriate reaction temperature.

The time required for heating and conditioning here depends on the desired crystal structure and can be from some minutes to some hours.

If the heating process takes place in essence via exposure to a process gas, the “quantity of gas:quantity of product” (mg/mp) used is from 1.5 to 15, in particular from 2.5 to 10, and the temperature of the product therefore in essence approximates to the temperature of the gas. “mp” here is the sum of all of the product streams introduced into the process, and “mg” here is the sum of all of the streams of gas introduced into the process. Examples of process gases that can be used are inert gases, such as nitrogen or CO₂, or a mixture made of inert gases. The process gases can comprise additives, where these either have a reactive effect on the product to be treated or become passively deposited on the product to be treated.

If the heating process uses a process gas in a circuit, sufficient fresh gas or purified process gas has to be added to this circuit to avoid any excessive increase in concentration of substances that diffuse out of the material.

There can be other assembles integrated into the process gas circuit, examples being heat exchangers, separation assemblies, such as filters or cyclones, gas-conveying assemblies, such as blowers, compressors or fans, gas-purification systems such as gas scrubbers, combustion systems or adsorption systems, or devices such as flaps, valves, or diverter systems.

A typical time for heating and conditioning for polyethylene terephthalate is from 10 minutes to 2 hours, with a typical conditioning temperature of from 200° C. to 245° C. The oxygen content of the inert gas is intended to be below 500 ppm, in particular below 100 ppm. In one variant, the heating process takes place within a period smaller than 10 minutes. This is described in the specification WO02/068498, incorporated concomitantly into the present invention.

Particularly suitable apparatuses for the preheating process are chevron-plate apparatuses (as described by way of example in DE 4300913 A1), crossflow apparatuses (as described by way of example in EP-1 019 663 A1), and also counterflow apparatuses (as described by way of example in CN-101579610 A (corresponds to the associated Swiss patent application CH 0735/08)). The relevant content of the abovementioned patent applications is incorporated by way of reference into this application. The preheating process can take place in one or more apparatuses. The size of the required apparatuses here is stated by giving the sum of all of the apparatus volumes, and the resultant apparatus volumes for treating from 40 to 100 metric tons/h are from 50 to 300 m³, with apparatus heights in the range from 10 to 50 m.

The heating process has to be followed by a step for reacting the heated polyester prepolymer particles, in order to obtain polyester particles with intrinsic viscosity of from 0.70 to 0.95 dl/g, in particular above 0.75 dl/g. The increase in intrinsic viscosity here is intended to be at least 0.05 dl/g, in particular at least 0.1 dl/g.

The reaction of the heated polyester prepolymer particles takes place in a suitable, in essence vertical, reactor. The introduction of the heated polyester prepolymer particles in the invention takes place into the upper portion of the reactor, and the polyester particles therefore flow downward through the reactor under gravity. The form in which the polyester particles flow through the reactor here is that of a fixed bed, also termed a moving fixed bed. The aim here is to minimize the breadth of the residence time range for the individual particles, and to avoid fluidization or any other type of active mixing of the particles.

There can be a plurality of heating apparatuses connected to a reactor. The reaction usually takes place in one reactor. The reaction can optionally take place in two or more reactors operated in series, where the features of the invention are used in operation of each individual reactor.

The reaction in the invention takes place in a reactor to give an IV value>0.7 dl/g. Further reactors for a further treatment step can optionally follow.

The reaction takes place in a temperature range from 5 to 80° C. below the crystalline melting point of the polyester particles, and preference is given here to temperatures which are below the crystalline melting point of the polycondensate particles by less than 60° C. and/or by more than 20° C. The reaction, and continuing crystallization during the reaction, can increase the temperature of the polyester particles by from 1 to 20° C., but the intention here is that the resultant maximum temperature is also within the range of appropriate reaction temperature.

The appropriate reaction time is from 6 to 30 hours, but for economic reasons preference is given here to residence times of less than 24 hours, in particular less than 20 hours, but more than 8 hours.

In one preferred embodiment of the present invention, the process gas flows through the polyester particles in the reactor. Process gases that can be used are inert gases, such as nitrogen or CO₂, or a mixture made of inert gases. The process gas can comprise additives, where these either have a reactive effect on the product to be treated or become passively deposited on the product to be treated. The process gas is in essence circulated. The process gas has to be scrubbed to remove undesired products, in particular cleavage products from the polycondensation reactions, in order to avoid impairment of the polycondensation reaction. The intention here is to reduce the levels of typical cleavage products to values below 1000 ppm, examples being water, diols (e.g. ethylene glycol, propanediol, butanediol), and aldehydes (e.g acetaldehyde). The intention here is to reduce the level of cleavage products from the reversible polycondensation reactions to values below 1000 ppm. The ppm data are stated in the form of proportions by weight. The purification process can use gas-purification systems known from the prior art, for example catalytic combustion systems, gas scrubbers, adsorption systems, or cold traps. Catalytic combustion systems are known by way of example from WO00/07698, EP0660746B2 and DE102004006861A1, incorporated concomitantly into the present invention. It is possible to use a plurality of purification systems. Additional purification steps can be provided. Removal of solids can by way of example be achieved via filters or cyclones. Various streams of inert gas can be combined for purification purposes into one gas-purification system, or can be treated individually. A quantity of fresh process gas is also usually introduced into the circuit.

There can be further assemblies integrated into the process gas circuit, examples being heat exchangers, gas-conveying assemblies, such as blowers, compressors, or fans, or devices such as flaps, valves, or diverter systems.

The appropriate postcondensation temperature for polyethylene terephthalate is in the temperature range from 190° C. to 240° C., preference being given here to temperatures below 225° C.

Particular cleavage products produced here from the reversible polycondensation reactions are water and ethylene glycol.

If the reaction process takes place in essence via exposure to a process gas, the “quantity of gas : quantity of product” (mg/mp) used is from 0.2 to 2, in particular from 0.6 to 1.4, and the temperature of the gas therefore in essence approximates to the temperature of the product. “mp” here is the sum of all of the product streams introduced into the process, and “mg” here is the sum of all of the streams of gas introduced into the process. One or more streams of gas can be introduced into a reactor, where these in particular differ in their temperature. The temperature of a process gas introduced can be above, within, or below the temperature range of the appropriate reaction temperature. If the intention is not to alter the temperature of the polyester particles during gas input, the process gas has to be heated to the temperature of the polyester particles. If the intention is to lower the temperature of the polyester particles during gas input, a lower temperature can be used for the process gas introduced.

The process gas is usually introduced at the bottom of the reactor and removed at the top of the reactor, thus giving a stream of process gas in countercurrent to the flow of the polyester particles. However, it is also possible to use an opposite method with cocurrent flow from the top of the reactor to the bottom of the reactor. The resistance to flow within the reactor comprising polyester particles produces a pressure difference between gas input and gas output, and this pressure difference depends on the height of the reactor, the size and shape of the polyester particles, and also the gas velocity, and therefore the quantity of gas and the diameter of the reactor.

According to one preferred embodiment of the present invention, the pressure difference between the gas inlet into the reactor and the gas outlet from the reactor is from 450 to 1000 mbar. Preference is given to pressure differences above 500 mbar and below 900 mbar. There is a gauge pressure here of from 20 to 300 mbar present at the reactor outlet, and it is possible here to reduce the gas velocity in the reactor and thus the pressure drop in the reactor by using a relatively high outgoing pressure, preferably more than 50 mbar, in particular more than 100 mbar.

Suitable reactors are tower reactors, also termed fixed-bed reactors or moving-bed reactors. The shape of a tower reactor is usually cylindrical, with, for example, round or rectangular cross section. The reactor terminates in a cover at the top and in an outlet cone at the bottom. The L/D ratio of a reactor with diameter (D) and length (L) is usually from 5 to 11. L is the cylindrical length of the reactor without the outlet cone, and D is the average diameter along the cylindrical length, and in the case of round cross sections it is the diameter that is used directly, and in the case of square cross sections it is the edge length that is used, and in the case of irregular cross sections it is the square root of the cross-sectional area that is used.

The size of the required reactors here is stated by giving the sum of all of the reactor volumes, and the resultant reactor volumes for treating from 40 to 100 metric tons/h are from 400 to 3000 m³, in particular greater than 500 m³ with apparatus heights inclusive of the outlet cone in the range from 30 to 60 m, in particular greater than 40 m.

The reactor can have internals, where these by way of example serve to increase the uniformity of the flow conditions, or as gas inlet, or to reduce product pressure. Reactors of this type are described by way of example in the specifications EP1337321B1, U.S. Pat. No. 6,010,667 and DE102007031653A1, incorporated concomitantly into the present invention.

In order to inhibit heat loss, the reactor can have external insulation and/or have heating elements. Any possible supply lines for the polyester particles here can have been incorporated into the reactor or at least into the insulation around the reactor, thus permitting reduction of heat loss from the conveying line.

The mass flow rate at which the polyester prepolymer particles are introduced into the reaction step in the invention is from 40 to 100 metric tons per hour, and in particular the mass flow rate at which the polyester prepolymer particles are introduced into a reactor is from 40 to 100 metric tons per hour.

The descent velocity of the polyester particles in the reactor is from 2 to 6 meters per hour in the invention. The descent velocity is preferably above 2.2 meters per hour, more preferably above 2.6 meters per hour, in particular above 3 meters per hour. The descent velocity is calculated here by dividing the mass flow rate of the particles by the bulk density of the particles and dividing the result by the average cross-sectional area of the reactor.

The flow rate of the polyester prepolymer particle product within and from the reactor is regulated via shut-off devices, such as rotary valves, slides, and/or conveying devices.

The high descent velocity of the polyester particles within the reactor produces increased relative motion of the individual particles with respect to one another. This reduces the tendency of the polyester pellets to adhere, thus permitting treatment at relatively high temperatures, and this in turn reduces the residence time required, and thus the ‘reactor size required. The relatively low tendency toward adhesion here is explained by the short contact time between two respective surfaces of two particles, reducing the amount of temperature-dependent exchange of freely movable chain ends across the surfaces. Because the reaction rate is likewise temperature-dependent, the residence time for any particular increase in intrinsic viscosity becomes lower. Reactor size can therefore be reduced by increasing the descent velocity for a given limiting tendency of a product toward adhesion.

If the concentration of terminal groups in the polyester, in particular in a polyethylene terephthalate, is measured prior to and after the reaction, the number of esterification reactions (E) and of transesterification reactions (T) per metric ton of material can be determined.

E=c_{COOH} initial−c_{COOH} final a)

T=(c_{OH} initial−c_{OH} final−E)/2 b)

On the basis of the resultant proportions it is possible to determine whether most of the reaction is preceding by way of an esterification reaction, E/(E+T)>0.5, or whether most of the reaction is preceding by way of a transesterification reaction E/(E+T)<0.5. The intention in one preferred embodiment of the invention is that more than 50% of the reaction proceeds by way of an esterification reaction, in particular more than 65%, and preferably more than 70%. Any possible reactions in the preceding steps for the crystallization process and for the heating process are also included for this purpose.

The preferential esterification reaction reduces the tendency of a product toward adhesion, and this in turn permits the use of higher reaction temperatures and thus smaller reactors.

The polyester prepolymer particles are usually introduced via a conveying system to the upper portion of the reactor after the heating process.

In one embodiment of the present invention, the polyester prepolymer particles are conveyed into the reactor from an initial level (H0) to an input level (HR), and the input level (HR) is at a location higher by from 40 to 80 m, preferably more than 45 m, in particular more than 50 m, than the output level (H0). A resultant advantage is that apparatuses for the heating process can be installed at a low level in the building and do not have to be arranged above the reactor. Arranged above the reactor, there can optionally be a buffer container and/or an apparatus for dust-removal from the polyester prepolymer particles, whereupon the level of entry into the buffer container and/or the dust-removal apparatus then determines the entry level (HR). If the dust-removal process involves exposure to a process gas, an increase or reduction of the temperature of the product can be achieved thereby, whereupon in particular corrections in the range +/−20° C. take place.

Suitable conveying apparatuses are mechanical conveying apparatuses, such as screw-, chain-, or bucket-conveyor apparatuses, and also pneumatic conveying apparatuses.

Pneumatic conveying apparatuses for low conveying velocities, operated using an inert gas, are particularly suitable. A pneumatic conveying apparatus for low conveying velocities here encompasses at least one feed region into which both product and conveying gas are introduced, one apparatus for increasing the pressure of the conveying gas, one product-metering apparatus, one conveying line for transportation of the product-gas mixture from the feed region, and also valves for regulating the supply of conveying gas. The feed region here can be composed of one or more containers or merely of an inlet hopper leading to the conveying line. The apparatus for increasing the pressure of the conveying gas here can encompass a compression device, such as a compressor or fan, and also any possible buffer tanks. The conveying gas can be subjected not only to the pressure increase but also to a further heating process. A metering apparatus can encompass rotary valves, slides, or metering screws. For continuous operation, particular preference is given to rotary valves, and in the case of conveying over large distances here, therefore involving large pressure losses, it is advantageous to use two valves arranged in succession, since this reduces the pressure drop across the conveying valve and thus reduces the amount of gas leakage.

The conveying line can be composed of a plurality of horizontal, vertical, or inclined subsections and curved pipe sections. The radii of curved pipe sections here are intended to be more than 3 times, in particular more than 4 times, but usually less than 10 times, the diameter of the pipeline. The diameter of the conveying line can change in the course of the conveying section in order, for example, to compensate for the expansion of the conveying gas as pressure falls. There are transition sections here connecting individual subsections with different diameter. The valves can be used to control the supply of conveying gas in alternating fashion upstream and downstream of the feed region, in order to form blocks of product which are then forced through the conveying line.

In one preferred embodiment of the present invention, the heated polyester prepolymer particles are conveyed through two or more conveying lines. This firstly allows the throughput rate through a conveying line to be limited. Secondly, there can be a parallel conveying line provided as a backup line, in order to prevent any possible production stoppages caused by failure of one conveying line. Allocated to each conveying line, there can be apparatuses for increasing pressure and for metering, and also valves. However, it is also possible to connect one apparatus for pressure increase and/or for the heating of the conveying gas to two or more conveying lines.

The temperature of the conveying gas is selected in such a way that the temperature of the polyester prepolymer particles does not alter substantially during conveying, in particular alters by less than +/−10° C., and in particular the intention is to avoid any temperature rise. Conveying-gas temperatures usually used are in the range from 60° C. to 250° C., preferably above 100° C. and below 230° C., in particular above 150° C.

In one preferred embodiment of the present invention, the conveying of the heated polyester prepolymer particles takes place at a conveying temperature (TF) which is preferably below the crystalline melting ‘point of the polyester by from 5 to 80° C., in particular more than 20° C., and less than 60° C. The conveying temperature (TF) in the case of polyethylene terephthalate production is preferably from 190° C. to 230° C., in particular above 200° C. and below 225° C. The conveying temperature here is the temperature of the polyester prepolymer particles at the end of the conveying section.

In one preferred embodiment of the present invention, the conveying of the heated polyester prepolymer particles takes place via a conveying line with an internal diameter (DF) of from 250 mm to 500 mm, in particular above 290 mm and below 450 mm. The cross section of the conveying line here is usually round. In the case of a round cross section, DF is the free cross-sectional diameter, and in the case of any other cross section it is the square root of the free cross-sectional area.

According to another preferred embodiment of the present invention, the conveying of the heated polyester prepolymer particles takes place at a conveying velocity (vF) which is from 5 to 12 m/s. The conveying velocity here is the superficial velocity of the conveying gas under the given operating conditions in the subsection at the end of the conveying section, where the superficial velocity is the quantity of gas per unit of time divided by the cross section of the conveying line. The low conveying velocity in pipelines with relatively large diameter prevents excessive dust formation due to abrasion.

The mass of conveying gas here is preferably from 3% to 15%, in particular less than 10%, based on the mass of product conveyed.

The conveying line can end directly within the reactor or in a separator arranged thereabove. Entry into the reactor can occur from above through the cover or through the upper region of the reactor jacket. If two or more conveying lines are used, entry into the reactor can take place by way of a shared line or by way of separate lines, but preference is given here to separate entries, either in different directions or at some distance from one another, since the result is distribution of the particles within the reactor, and this leads to better utilization of the volume of the reactor.

The conveying gas is separated from the polyester prepolymer particles in the reactor or in the separator, and is either returned directly to the conveying system or mixed with another stream of inert gas. Prior to reuse, the conveying gas is usually purified, at least to remove polycondensate dust.

In addition to the conveying system between the heating process and the reaction process, further conveying systems can be used. In particular, conveying systems can be used between the particle production process and the crystallization process, between a plurality of steps of the crystallization process, between the crystallization process and the heating process, between the reaction process and the cooling process, after the cooling process, and also between a process step and any possible storage silo.

It is particularly preferable in the invention to provide a conveying system between the crystallization process and the preheating (heating) process. In a conventional system for carrying out a solid-phase polycondensation (SSP) process, the arrangement has the crystallizer above the preheater. In the case of a large system such as that provided by the present invention, however, the result would be arrangement of a very major process step in an upper region of the system (i.e. at a very high level in the building housing the system). This is very costly. It is therefore preferable in the invention to arrange the crystallizer alongside the preheater (i.e. in a lower region of the building). This requires conveying of the semicrystallized prepolymer particles from the outlet at the bottom of the crystallizer into the inlet at the top of the preheater. As far as the details of this conveying system are concerned (conveying height, conveying rates, etc.), reference can be made to the above statements relating to conveying into the reactor. The same measures can preferably be adopted for the conveying system between crystallizer and preheater.

However, it has unexpectedly been found here that when the arrangement has the crystallizer and preheater alongside one another in the lower region of the system, and has the associated conveying system, undesired dust contamination occurs in the preheater, unlike in conventional SSP systems. The dust contamination leads to formation of particles in the preheater that are difficult to melt, and therefore to very costly cleaning of the preheater after the system has run for a certain time.

Surprisingly, it has been found that this problem can be solved simply at a low cost by arranging a dust-removal apparatus at the end of the conveying section between crystallizer and preheater, preferably above the inlet into the preheater.

Dust is particles of a size that is markedly below the average pellet diameter. If the average pellet diameter is above 1 mm, particles which fall through a sieve with mesh width 500 μm are considered to be dust.

Dust can be removed by using mechanical energy, for example in vibratory sieves, inertial separators, or zig-zag separators, or by using a stream of gas, for example in fluidized-bed apparatuses or pneumatic separators. Deionizing streams of gas can be used to remove dust particles adhering to pellets as a result of electrostatic forces. Preferred dust-removal apparatuses are fluidized-bed apparatuses where the sieve area through which gas flows is from 0.5 to 10 m², in particular greater than 1 m² and smaller than 8 m², where the ratio of quantity of gas to quantity of product is from 1:15 to 1:1. The average residence time of the pellets in a dust-removal apparatus is in the region of a few seconds to 5 minutes, but it is also possible to use longer residence times in exceptional cases. The dust-removal process takes place at a temperature which in essence corresponds to the appropriate temperature range for the crystallization process.

The present process therefore preferably encompasses, in the invention, the step of treating a (semicrystalline) polyester in a fluidized-bed apparatus at a temperature in the range from 100 to 250° C., in particular from 130 to 200° C., with a specific throughput rate of from 10 to 100 metric tons/h per m² of sieve area, in particular greater than 15 metric tons/h per m² of sieve area. Surprisingly, this step achieves efficient dust removal from the semicrystalline prepolymer particles and thus considerably more efficient operation of the entire system.

Fluidized-bed apparatuses are known in the prior art and are described by way of example in the previously mentioned specification EP-1 425 146 A2. The apparatuses have at least one supply aperture for the particles from which dust is to be removed, and at least one output aperture for the particles from which dust has been removed. They also have at least one input aperture for the process gas used for the dust-removal process, and at least one output aperture for the dust-laden process gas. Between the at least one particle-input aperture and the at least one gas-input aperture, there is a sieve plate through which the process gas can flow, but through which the particles cannot flow, arranged in such a way that the process gas flows through the particles and fluidizes the same. Gas velocities suitable for the dust-removal process are in the range from 2 to 5 m/s superficial velocity, and in the case of pulsed streams of gas here the decisive factor is the maximum gas velocity.

The reaction process can be followed by a step for the cooling of the polyester polymer particles.

The polyester polymer particles here can be cooled to a temperature suitable for storage and for transport, or to a temperature for direct further processing. The cooling is achieved here by processes known in the prior art, for example in plate heat exchangers, in fluidized-bed coolers, in conveying systems with an excess of coolant, via direct introduction into a coolant liquid, via contact with a cold surface, or via a combination of various cooling methods. A portion of the cooling can take place before the material leaves the reactor, via addition of a cold stream of gas. Preferred cooling apparatuses are fluidized-bed coolers or cooling reactors, where a stream of gas is passed in countercurrent through these.

The polyester polymer particles can be processed to give various products, examples being fibers, tapes, foils, or injection moldings. Polyethylene terephthalate is in particular processed to give hollow products, such as bottles.

The present invention provides a process for producing polyester particles at high throughput in a line. Since individual process steps or process substeps can be carried out either in a single apparatus or in a plurality of apparatuses operated in parallel, the throughput rate of a line is determined by the throughput of the apparatus with the highest throughput rate. In one preferred embodiment of the present invention, at least one step of the crystallization process, of the heating process, or of the reaction process, takes place in a single apparatus with a mass flow rate of from 40 to 100 metric tons per hour.

The dependent claims define other advantageous embodiments.

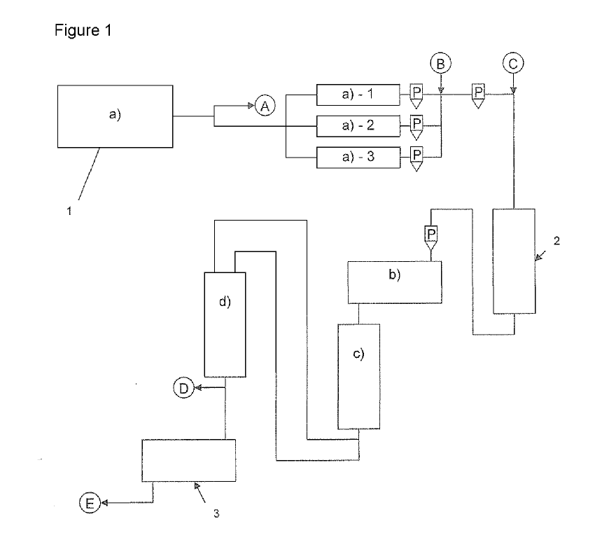

FIG. 1 shows one embodiment of the process of the invention. A polycondensate prepolymer melt 1 composed of polyethylene terephthalate with IV value of 0.60 dl/g and with a proportion of about 6% of comonomer (mol %, based on the respective monomer component) is produced at a production rate of 62.6 metric tons/h in a melt polymerization reactor a).

The temperature of the melt is about 285° C. The melt is divided into a plurality of melt lines and introduced into a plurality of pelletizers, but only pelletizers a)-1 to a)-3 have been shown. There are further pelletizers connected to point (A). The pelletizers are commercially available underwater strand pelletizers, as marketed as USG by way of example by Automatik Plastics Machinery. The pelletizers are composed of a die with a die plate which can produce a large number of melt strands, and with a region which is at a distance of from 1 mm to 300 mm from the die and which is designed to receive the melt strands and over which water flows, and with an inclined water-sprayed chute on which the melt strands are cooled and hardened, and with cutting equipment which includes intake rolls and cutter rolls and in which the strands are chopped to give individual pellets, and with a water-treatment system in which the cooling water is controlled to a temperature of from 30 to 50° C. and is filtered, and with a drying apparatus in which the pellets are separated from the process water, and with a classifying sieve in which oversize material and/or fines are removed. The pellets produced are of cylindrical shape, have a length of about 3 mm, and a diameter of about 2.4 mm, and weigh about 18 mg. The temperature of the pellets is about 50° C. The arrangement can optionally have a buffer container (P) following each pelletizer, or a buffer container (P) for a plurality of pelletizers. The pellets are conveyed via one or more pneumatic conveying systems into one or more storage silos 2, and the product stream from point (A) here is introduced at point (B) or (C). From the storage silos 2, one or more pneumatic conveying systems is/are in turn used to transport the prepolymer particles into an optional buffer container (P) and then into a crystallizer b). The temperature of input into the crystallizer can be from −20 to 90° C., varying with external temperature and with optional pretreatment. The particles are introduced into the crystallizer with metering by way of a rotary valve. The treatment in the crystallizer takes place under air. In the crystallizer, the particles are heated in a plurality of regions to a temperatute of about 165° C. in from 5 to 20 minutes by a hot fluidization gas, and are crystallized in this process to a degree of crystallization of about 35%. The crystallized particles pass through one or more further optional conveying systems into a preheater c), which is operated under nitrogen. The arrangement can, likewise optionally, have at least one dust-removal apparatus prior to the preheater. If the dust-removal apparatus is operated with a hot fluidization gas, there is a simultaneous temperature increase of from 1 to 20° C. Between crystallizer and preheater, the arrangement has at least one rotary valve, in order to avoid excessive carry-over of nitrogen. In the preheater, the particles are heated to a temperature of about 216° C. in about 30 to 120 minutes, by a hot stream of process gas, and the temperature is reduced by from 1 to 10° C. prior to discharge. The degree of crystallization of the particles rises to about 44% in this process. IV value rises to about 0.63 dl/g.

After discharge from the preheater, the hot particles are divided into two product streams each of about 31.3 metric tons/h. Two pneumatic hot-conveying procedures take place in parallel under nitrogen, each using 2.2 metric tons/h of conveying gas and a temperature of 200° C. In this procedure, the conveying system successfully handles a height difference of about 55 m, from the lowest to the highest point. The internal diameter of the pipeline increases from 180 mm to 280 mm over the course of the conveying section, the decisive internal diameter of the pipeline at the end of the conveying section here being 280 mm. Conveying velocity is thus kept constant in the range from 7 to 11 m/s, the decisive conveying velocity at the end of the conveying section here being 11 m/s. The average conveying temperature is 212° C. The conveying systems lead directly to the reactor d), and a separation distance here between the conveying lines at the reactor inlets produces two conical beds of material, thus improving utilization of reactor volume.

The amount of prepolymer particles introduced into the reactor is therefore 62.6 metric tons/h. The volume of the reactor is 687 m³ and its cylindrical height is 35 m. Residence time in the reactor is about 9 hours. Clean nitrogen is introduced at about 170° C. into the reactor from below. The ratio of quantity of gas to quantity of product is 1:3.2. The pressure drop across the reactor is about 700 mbar. The descent velocity of the particles in the reactor is 3.9 m/h. The treatment in the reactor increases intrinsic viscosity to a value of 0.86 dl/g. The polymer particles at point (D) can be used directly in the dry and hot state for further processing, for example to give preforms for PET bottles. Under the reactor, the arrangement has a cooler 3 in which the polymer particles are cooled in countercurrent with air. After cooling, the polymer particles emerging from point (E) are conveyed into storage silos 2 or transport containers.

The nitrogen from the reactor is first used as exchange gas in the preheater and then is purified by means of a gas scrubber operated with ethylene glycol to remove volatile components, such as ethylene glycol, water, and acetaldehyde, in a plurality of stages, and is cooled in this process to below 10° C. Residual water content is about 15 ppm, ethylene glycol content is about 25 ppm, and acetaldehyde content is about 75 ppm. Oxygen which penetrates into the system with the polymer or by way of the rotary valves is removed from a substream of the nitrogen via catalytic combustion at from 200 to 350° C. The acetaldehyde remaining in the stream of gas serves as fuel for this purpose, and the content thereof is thus further reduced. Purified nitrogen is reused as fresh gas for the reactor, as coolant gas at the end of the preheater, and also as gas for conveying materials from the preheater to the reactor.

The hot exhaust air from the cooler is purified by way of a cyclone to remove any possible residues of dust and is then passed as exchange gas into the crystallization circuit, with a possible resultant saving of the amount of energy needed to heat the exchange gas.

1.-19. (canceled)

20. A process for producing a thermoplastic polyester with the following steps:
a) producing polyester prepolymer particles with an intrinsic viscosity of from 0.35 to 0.75 dl/g,
b) crystallizing the polyester prepolymer particles to produce semicrystalline polyester prepolymer particles,
c) preheating the semicrystalline polyester prepolymer particles to a suitable reaction temperature for producing heated polyester prepolymer particles,
d) reacting the heated polyester prepolymer particles to produce polyester polymer particles with an intrinsic viscosity of from 0.70 to 0.95 dl/g,
where the reaction in step d) takes place in at least one reactor through which the particles flow under gravity,
where the residence time in the reactor is from 6 to 30 hours,
wherein the particles (1) are introduced at least into the step d) with a mass flow rate of from 40 to 100 metric tons per hour, and a descent velocity of from 2 to 6 meters per hour applies to the particles in the reactor.

21. The process according to claim 20, wherein the reaction in step d) takes place in a stream of inert gas, where reaction products from the reactions which increase the molecular weight of the particles are transferred into the gas and a pressure difference of from 450 to 1000 mbar prevails between the gas inlet into the reactor and the gas outlet from the reactor.

22. The process according to claim 20, wherein between the step b) of the crystallization process and the step c) of the preheating process, the polyester prepolymer particles are conveyed from an output level (HA) to an input level (HE) which is at a higher location.

23. The process according to claim 20, wherein prior to step c), the polyester prepolymer particles are passed through a dust-removal apparatus.

24. The process according to claim 20, wherein the terminal carboxy group content (X_{COOH}) of the polyester prepolymer particles from step a) is from 0.25 to 0.6, and that, during the treatment in steps b), c), and d), the proportion of the esterification reaction (E) in the polycondensation reactions (E+T) is from 0.5 to 1.

25. The process according to claim 20, wherein the heated polyester prepolymer particles from step c) are conveyed into the reactor from an initial level (H0) to an input level (HR), and the input level (HR) is at a location higher by from 40 to 80 m than the output level HO.

26. The process according to claim 20, wherein the conveying of the heated polyester prepolymer particles from step c) takes place at a conveying temperature (TF) which is below the crystalline melting point of the polyester by from 5 to 80° C.

27. The process according to claim 20, wherein the conveying of the heated polyester prepolymer particles from step c) is achieved by means of a pneumatic conveying system.

28. The process according to claim 20, wherein the conveying of the heated polyester prepolymer particles from step c) takes place via a conveying line with an internal diameter (DF) of from 250 mm to 500 mm

29. The process according to claim 20, wherein the conveying takes place at a conveying velocity (vF) which is from 5 to 12 m/s.

30. The process according to claim 20, wherein the conveying of the heated polyester prepolymer particles from step c) takes place via at least two conveying lines.

31. The process according to claim 20, wherein the particles are introduced at least into one individual apparatus of the steps b), c) or d) with a mass flow rate of from 40 to 100 metric tons per hour.

32. An apparatus for producing a thermoplastic polyester according to claim 20, said apparatus comprising
a) a melt polycondensation reactor a) for producing polyester prepolymer particles with an intrinsic viscosity of from 0.35 to 0.75 dl/g
b) at least one crystallizer b) for crystallizing the polyester prepolymer particles to produce semicrystalline polyester prepolymer particles
c) at least one preheater c) for heating the semicrystalline polyester prepolymer particles to a suitable reaction temperature for producing heated polyester prepolymer particles
d) at least one reactor d) for producing polyester polymer particles with an intrinsic viscosity of from 0.70 to 0.95 dl/g, wherein prior to the preheater c), the arrangement has a dust-removal apparatus, and the level of input (HR) into the reactor d) is at a location higher by from 40 to 80 m than the level of output HO from the preheater c).

33. The apparatus according to claim 32, wherein the reactor d) can be operated with a mass flow rate of from 40 to 100 metric tons of particles per hour, with a residence time of the particles in the reactor d) of from 6 to 30 hours, and with a descent velocity of from 2 to 6 meters per hour for the particles in the reactor d).

34. The apparatus according to claim 32, wherein there are at least two conveying lines connecting the preheater c) and the reactor d) to one another.

35. The apparatus according to claim 34, wherein the conveying lines have been introduced separately into the reactor d), where the inputs are in different directions or have been arranged at a great distance from one another.

36. The apparatus according to claim 34, wherein the conveying lines have internal diameters (DF) of from 250 mm to 500 mm.

37. The apparatus according to claim 32, wherein the crystallizer b) and the preheater c) have been arranged alongside one another, and a conveying line connects these.

38. A process for dust-removal from semicrystalline polyester prepolymer particles, wherein the dust-removal process takes place in a fluidized-bed apparatus at a temperature in the range from 100 to 250° C., with a specific throughput rate of from 10 to 100 metric tons/h per m² of sieve area.
